(19) United States
(12) Patent Application Publication
(10) Pub. No.: US 2008/0134851 A1
(43) Pub. Date: Jun. 12, 2008

(54) CUTTING APPARATUS WITH A CUTTING TIP SENSOR

(76) Inventors: William A. Roach, Lake Lillian, MN (US); Percy A. Parr, Bloomington, MN (US); Chad A. Chryst, Andover, MN (US)

Correspondence Address: QUARLES & BRADY LLP, 411 E. WISCONSIN AVENUE, SUITE 2040, MILWAUKEE, WI, 53202-4497, US

(21) Appl. No.: 11/608,338

(22) Filed: Dec. 8, 2006

(51) Int. Cl. B26D 3/00

(52) U.S. Cl. 83/56

(57) ABSTRACT

A sheet cutting apparatus that automatically adjusts blade depth for a sheet being cut regardless of the amount of wear on the blade. The apparatus includes a top plate for supporting a sheet being cut. A cutting head is disposed above the top plate and has a cutting blade movable toward the top plate. The cutting blade includes a cutting blade tip which engages a cutting blade tip sensor to indicate a location of the tip relative to the cutting head.

### CROSS REFERENCES TO RELATED APPLICATIONS

This application is related to copending U.S. patent application entitled “Cutting Head,” Attorney Docket No. 180825.00057, filed concurrently with the present application.

### STATEMENT REGARDING FEDERALLY SPONSORED RESEARCH

Not Applicable

### TECHNICAL FIELD

The present invention relates to a sheet cutting system, and more particularly to a cutting system having a cutting tip sensor.

### DESCRIPTION OF THE BACKGROUND ART

There are a number of U.S. patents that disclose cutting systems having a cutting head movably mounted on a gantry system for moving the cutting head in two dimensions, such as U.S. Pat. Nos. 3,967,519, 4,624,169, 4,524,894, 4,793,033, 5,262,617, and 5,275,077. The cutting blades in these prior art cutting systems are subject to wear requiring periodic manual adjustments by a technician to obtain reliable cut output.

Prior art cutting systems are often used to cut sheets of material having different characteristics that require a specific blade depth into the sheet. Adjusting the blade depth requires manual adjustment by the technician to set the desired length of the blade extending from the cutting head. This operation requires careful measuring and adjustment which must be repeated for each change in blade depth. Therefore, a need exists for a cutting system that does not require manual adjustments in order to change a blade depth or obtain reliable cut output.

### SUMMARY OF THE INVENTION

The present invention provides a sheet cutting apparatus that automatically adjusts blade depth for a sheet being cut regardless of the amount of wear on the blade. The apparatus includes a top plate for supporting a sheet being cut. A cutting head is disposed above the top plate and has a cutting blade movable toward the top plate. The cutting blade includes a cutting blade tip which engages a cutting blade tip sensor to indicate a location of the tip relative to the cutting head.

A general objective of the present invention is to provide a cutting system that does not require manual adjustments in order to change a blade depth or obtain reliable cut output. This objective is achieved in one embodiment by providing a cutting system including a cutting blade tip sensor that determines the location of the blade tip relative to the cutting head.

The foregoing and other objectives and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims herein for interpreting the scope of the invention.

### BRIEF DESCRIPTION OF THE DRAWINGS

FIG. 1 is a rear top perspective view of a cutting apparatus incorporating the present invention;

FIG. 2 is a front top perspective view of the cutting apparatus of FIG. 1 with the cross arm housing cover open;

FIG. 3 is a transverse sectional view of the cutting apparatus of FIG. 1 with the cutting blade engaging the cutting tip sensor;

FIG. 4 is a front view of the cutting head of FIG. 2;

FIG. 5 is a front view of the cutting head of FIG. 4 with the blade extended;

FIG. 6 is a top view of the cutting head of FIG. 4;

FIG. 7 is a sectional view along line 7-7 of FIG. 6;

FIG. 8 is a perspective view of the cutting head of FIG. 4 with the cutting assembly pivoted to the blade replacement position; and

FIG. 9 is a side view of the cutting head of FIG. 8.

### DETAILED DESCRIPTION OF THE PREFERRED EMBODIMENTS

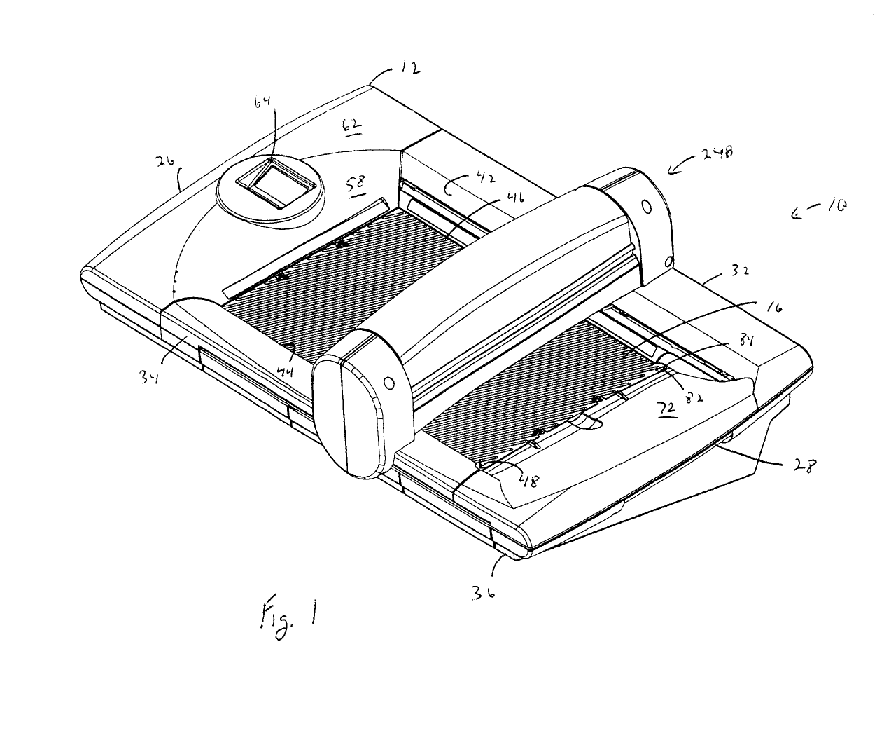

Referring particularly to FIGS. 1-3, a sheet cutting apparatus 10 employing a preferred embodiment of the present invention includes a housing 12 enclosing a vacuum manifold 14 and surrounding a porous top plate 16 that supports a sheet of material being cut. A cutting head 18 is supported above the top plate 16 for movement in two dimensions over the top plate 16, and thus the sheet material. A cutting blade 22 extendible from the cutting head 18 is engageable with a cutting blade tip sensor 24 adjacent to the top plate 16 to calibrate the length of the cutting blade 22 extending from the cutting head 18.

The housing 12 is preferably molded plastic having opposing front and rear exterior ends 26, 28 joined by opposing exterior side walls 32, 34 supported by an integral base 36. Interior side walls 42, 44 spaced inwardly from the exterior side walls 32, 34 are adjacent opposing sides 46, 48 of the top plate 16. The interior side walls 42, 44 extend downwardly from side covers 52, 54 short of the top plate 16 and define opposing longitudinal slots 56 along the length of the top plate 16.

A front interior end wall 58 spaced from the front exterior end 26 abuts the interior side walls 42, 44 and is joined to the front exterior end 26 by a front end cover 62. A space defined beneath the front end cover 62 houses circuitry, such as a microprocessor, motor control, and the like, that communicates with an external computer or network and controls the position and operation of the cutting head 18. An LCD display and keypad 64 extend through the front end cover 62 and provide a user interface for operational control of the apparatus 10. Likewise, a start/stop switch, power jack 66, and communication port 68 electrically connected to the circuitry extend through the front exterior end 26.

A rear interior end wall 72 abutting the interior side walls 42, 44 slopes upwardly from the top plate 16 toward the rear exterior end 28. Advantageously, the sloping rear interior end wall 72 provides a run out for the cutting head 18 allowing the cutting head 18 to move out of a cutting area on the top plate 16. In addition, the sloping rear interior end wall 72 simplifies insertion and removal of a sheet beneath the cutting head 18.

The top plate 16 includes a top surface 74 having grooves 76 in fluid communication with a vacuum source disposed in the housing 12. Preferably, each groove 76 is in fluid communication with an aperture 78 formed through the top plate 16 which fluidly communicates the groove 76 with the vacuum manifold 14 or plenum disposed beneath the top plate 16. Advantageously, the grooves 76 distribute the vacuum generated by the vacuum source across the top surface 74 to uniformly hold a sheet being cut in place on the top plate 16. Although grooves 76 formed in the top surface 74 of the top plate 16 are preferred because of the reduced cost over a perforated plate, a perforated plate disposed above the vacuum source can be used without departing from the scope of the invention. A porous replaceable cutting mat covering the top surface 74 can be provided to further distribute the vacuum. Advantageously, the cutting mat provides a penetrateable surface beneath the sheet being cut to minimize blade damage.

As shown in FIG. 3, the cutting blade tip sensor 24 is mounted in the housing 12 adjacent the top plate 16 and accessed through an aperture 82 formed in a surface 84. Preferably, the surface 84 is adjacent to the top plate 16 and forms part of the housing 12 to maximize the sheet size that can be accommodated on the top plate 16. However, the surface 84 can be the top surface 74 of the top plate 16 without departing from the scope of the invention.

The cutting blade tip sensor 24 in the form of an optical sensor is electrically connected to the circuitry and includes a spring-biased sensor plunger 86 extending into the surface aperture 82 in a non-extended position. A tip 88 of the sensor plunger 86 is substantially flush with the surface 84 surrounding the aperture 82 to properly determine the location of a tip 92 of the cutting blade 22 relative to the cutting head 18. A spring 94 biases the sensor plunger 86 upwardly toward the non-actuated position. The cutting blade tip sensor 24 is actuated by urging the sensor plunger 86 downwardly against the force of the spring 94 toward an actuated position. Upon reaching the actuated position, the cutting blade tip sensor 24 sends a signal to the circuitry indicating that the cutting blade tip sensor 24 has been actuated. Although a cutting blade tip sensor 24 in the form of an optical sensor is preferred, any sensor that can determine the location of a cutting tip of the blade can be used, such as a limit switch, sonic sensor, and the like, without departing from the scope of the invention.

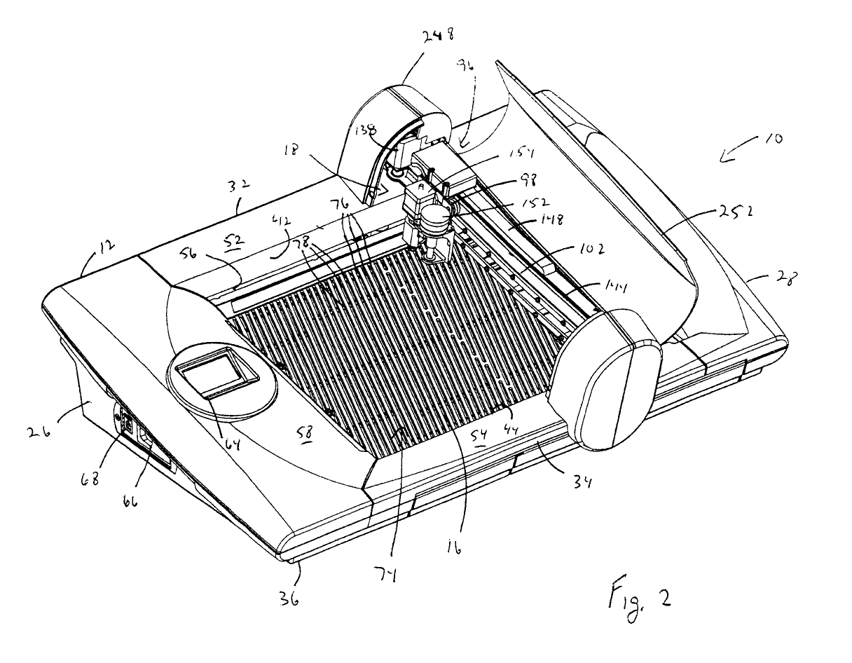

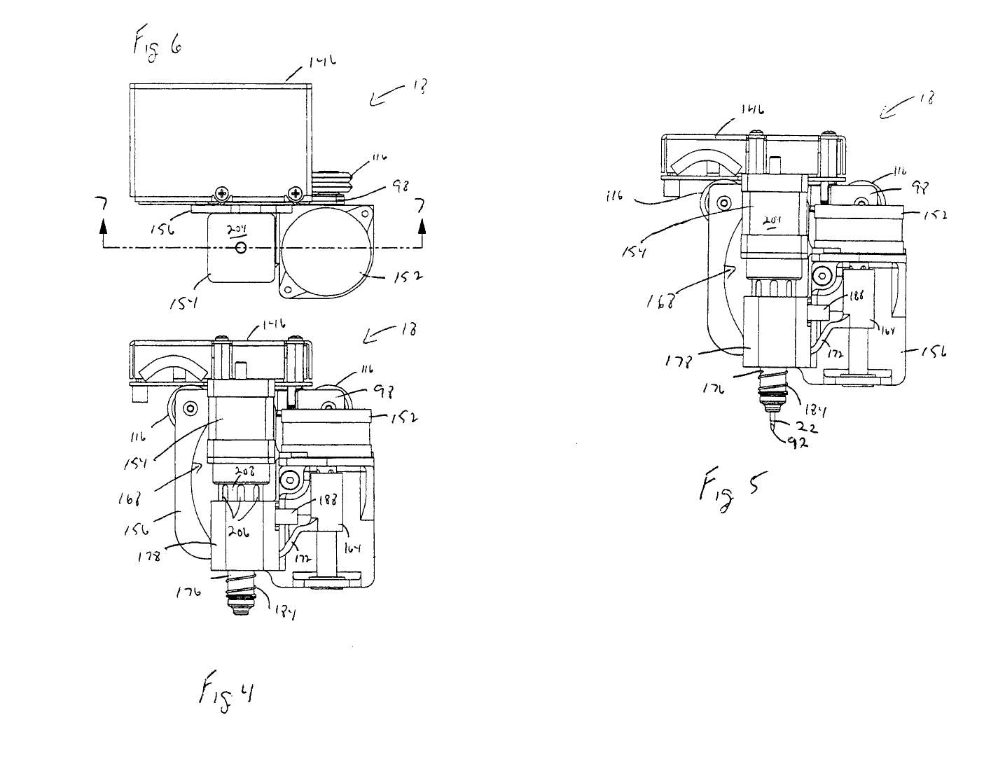

Referring now to FIGS. 2-6 and 9, the cutting head 18 is supported over the top plate by a gantry system 96 including a carriage 98 movably mounted on a cross bar 102. The cross bar 102 extends over the top plate 16 between the interior side walls 42, 44. Support arms 104 extend from each end of the cross bars 102 into the slots 56. Each support arm 104 is movably fixed to a trolley 106, such as by a mechanical fastener, engaging a side rail 108 extending beyond the length of the top plate 16 beneath one of the side covers 52. A trolley stepper motor controlled by the circuitry and disposed in the housing 12 is connected to each trolley 106 by a drive cable. Operation of the stepper motor moves the trolleys 106 along the respective side rail 108 to move the cross bar 102 over the top plate 16 between the housing front and rear interior end walls 58,72. Preferably, the trolleys 106 include wheels 112 engaging the respective side rail 108 to minimize friction as the trolleys 106 move along the length of the side rails 108.

The carriage 98 is movably mounted on the cross bar 102 for movement between the interior side walls 42, 44 over the top plate 16. Upper grooved wheels 116 rotatably mounted on a rear side 118 of the carriage 98 engage an upper rail 122 extending the length of the cross bar 102. Likewise, lower grooved wheels 124 rotatably mounted on the rear side 118 of the carriage 98 engage a lower rail 126 extending the length of the cross bar 102. A slot 128 interposed between the upper and lower rails 122, 126 receives an end 132 of a shoulder bolt 134 pivotally fixing the cutting head 18 to the carriage 98. Advantageously, the upper and lower rails engaging the grooved wheels 116, 124 fix the carriage 98 to the cross bar 102 while allowing the carriage 98 to move the length of the cross bar 102.

A carriage stepper motor 138 controlled by the circuitry and mounted on one end 142 of the cross bar 102 is connected to the carriage 98 by a drive cable 144. Operation of the carriage stepper motor 138 moves the carriage 98 along the cross bar 102 to move the carriage 98 over the top plate 16 between the interior side walls 42, 44. Although a gantry system 96, such as described above is preferred, for moving the cutting head 18 in two dimensions above the top plate 16, any known gantry system can be used without departing from the scope of the invention.

Additional circuitry controlling the cutting head 18 is housed in a control box 146 mounted to the carriage 98. A conductor ribbon 148 electrically connects the additional circuitry to the circuitry in the housing 12. The additional circuitry is electrically connected to a head pressure motor 152 and a fine adjust motor 154 forming part of the cutting head 18 and sensors mounted on the carriage 98.

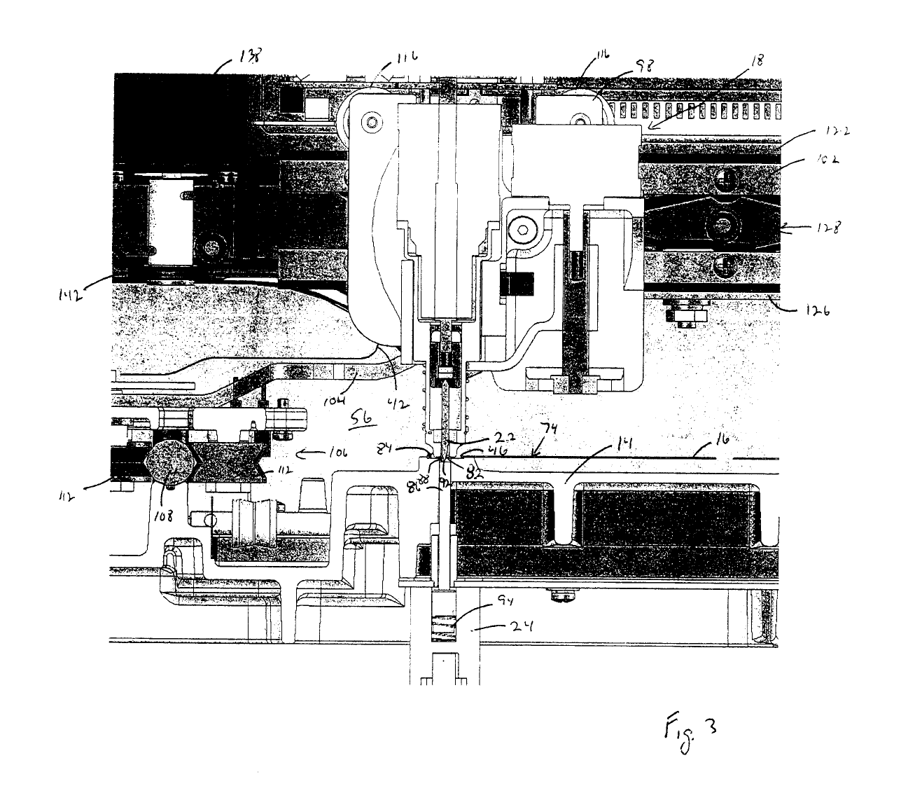

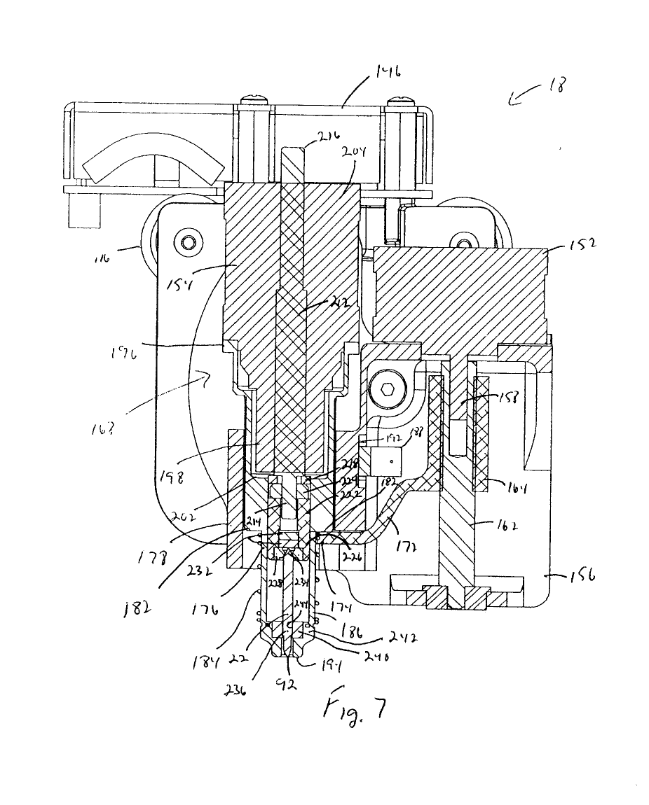

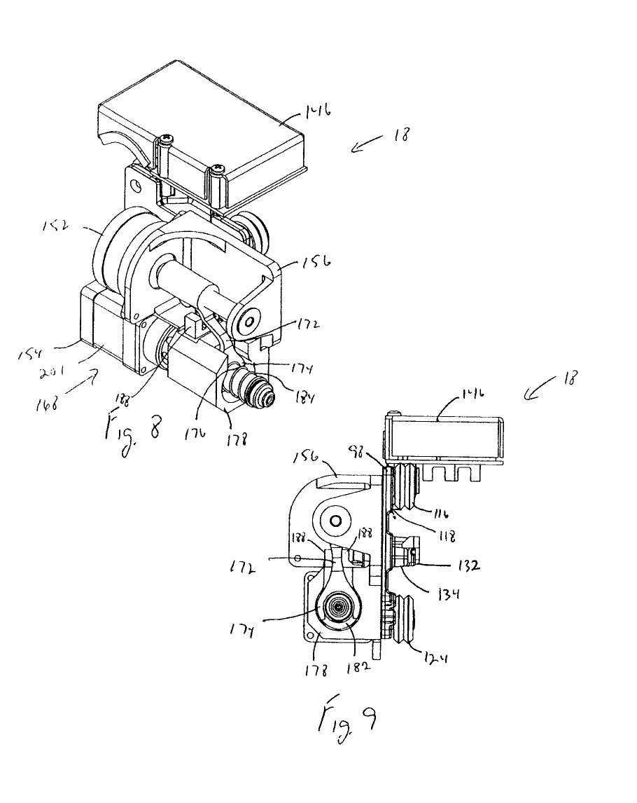

Referring to FIGS. 4-9, the cutting head 18 is pivotally fixed to the carriage 98 for pivotal movement about the shoulder bolt 134 between a cutting position (shown in FIG. 4) and a blade replacement position (shown in FIG. 8). Preferably, a ball detent or other locking device is provided to lock the cutting head 18 in the cutting position and/or the blade replacement position. Advantageously, the pivoting cutting head provides access to the cutting blade 22 mounted in the cutting head 18 for easy replacement.

A cutting head bracket 156 forming part of the cutting head 18 pivots about the shoulder bolt 134 and supports the head pressure motor 152, such as a stepper motor, having a downwardly extending rotatable head pressure shaft 158. The head pressure shaft 158 is coupled to a rotatable screw 162 threadably engaging a support nut 164 that supports a cutting blade assembly 168 including the fine adjust motor 154. Rotation of the head pressure shaft 158 rotates the screw 162 which axially moves the support nut 164, and thus the cutting blade assembly 168, between an upper position and a lower position. Although a head pressure motor 152 in the form of a stepper motor is preferred, the head pressure motor 152 can be any linear actuator, such as a solenoid, pneumatic cylinder, and the like, that can move the cutting blade assembly 168 between the upper position and lower position.

The support nut 164 includes a radially extending support arm 172 having a yoke shaped distal end 174 that wraps partially around a sleeve 176 extending downwardly from the cutting blade assembly 168 through a collar 178 fixed to the cutting head bracket 156. The yoke shaped distal end 174 engages a step 182 formed in the sleeve 176 to axially support the axially free floating sleeve 176 in the collar 178, as the support nut 164 moves the cutting blade assembly 168 between the upper position and a lower position. A helical spring 184 wrapped around a lower portion 186 of the sleeve 176 urges the sleeve 176 into engagement with the sheet being cut at a constant force during the cutting operation when the cutting blade assembly 168 is in the lower position.

The collar 178 radially supports the sleeve 176 as the cutting blade assembly 168 moves between the upper position and a lower position. A cutting blade assembly position sensor 188 extending from an external face 192 of the collar 178 receives the radially extending support arm 172 therebetween. The cutting blade assembly position sensor 188 is triggered by a flag on the support arm 172 and provides a known reference point to control the blade pressure as the head pressure motor 152 moves the cutting blade assembly 168 between the upper and lower positions.

The stepped cylindrical sleeve 176 has a distal end 194 including the lower portion 186 and an open proximal end 196. A substantially square upper portion 204 of the fine adjust motor 154 engages the open proximal end 196 to support a cylindrical lower portion 198 of the fine adjust motor 154 received in the open proximal end 196. The substantially square upper portion 204 is in close proximity to the cutting head bracket 156 and restricts rotation of the fine adjust motor 154 in the collar 178. Grooves 206 formed in an external surface 208 of the sleeve 176 reduce the surface area of the external surface 208 engaging an internal surface of the collar 178 and minimize friction as the sleeve 176 slidably moves between the upper and lower positions.

The fine adjust motor 154 is preferably a hybrid stepper linear actuator including an axially movable shaft 212 having a threaded lower end 214 extending downwardly into the sleeve 176 and an upper end 216 extending upwardly above the fine adjust motor upper portion 204. The shaft 212 extends into an upper end 218 of a cylindrical blade plunger 222 slidably received in the lower portion of the sleeve 176. An external nut 224 fixed to the axially movable blade plunger 222 threadably engages the threaded shaft 212. Linear movement of the shaft 212 axially drives the external nut 224, and thus the blade plunger 222, between an extended position and a retracted position.

A lower end 226 of the blade plunger 222 receives a thrust bearing 228 fixed to the blade plunger 222. Preferably, a pair of magnets 232 received in the plunger 222 magnetize the metallic thrust bearing 228 to detachably hold a conical upper end 234 of the cutting blade 22 in the lower portion 186 of the sleeve 176. Although magnets 232 holding the cutting blade 22 in the lower portion 186 of the sleeve 176 is preferred, other methods for holding the cutting blade 22 in the sleeve 176, such as a snap fit, set screw, and the like, can be used without departing from the scope of the invention.

The cutting blade 22 includes the conical upper end 234 and a lower cutting end 236 including the cutting blade tip 92 which extends through a radial bearing 240 received in an open lower end 242 of the lower portion 186 of the sleeve 176. The radial bearing 240 includes a central aperture 244 aligned with the open lower end 242 of the lower portion 186 of the sleeve 176. The cutting blade 22 is slidably received in the radial bearing central aperture 244 and extends through the open lower end 242 of the lower portion 186 of the sleeve 176 when the plunger 222, and thus the cutting blade 22, is moved axially toward the extended position.

Referring back to FIG. 2, a cross arm housing 248 covers the cross bar 102 and cutting head 18. A hinged cover 252 provides access to the cross bar 102 and cutting head 18 for maintenance and cutting blade 22 replacement. Although the cross arm housing 248 with the hinged cover 252 is preferred, the cross arm housing can be eliminated without departing from the scope of the invention.

Referring to FIGS. 1-9, in use, the vacuum created by the vacuum source draws the sheet being cut against the top plate 16 and firmly holds the sheet during a cutting operation. The external computer communicates with the sheet cutting apparatus circuitry through the communication port to control the gantry system 96 and cutting head 18 to set the desired blade depth for the sheet being cut and move the cutting head 18 along a desired path to cut a desired pattern into the sheet. Prior to the cutting head 18 beginning a cutting operation, the cutting head 18 is moved over to the cutting blade tip sensor 24, such that the cutting blade 22 is positioned directly over the sensor 24.

Once the cutting blade 22 is directly over the cutting blade tip sensor 24, the head pressure motor 152 lowers the cutting blade assembly 168 to the lower position in which the distal end 194 of the sleeve 176 engages the surface 84 surrounding the cutting blade tip sensor 24 compressing the helical spring 184. Once the cutting blade assembly 168 is in the lower position, the fine adjust motor 154 extends the cutting blade 22 toward the extended position until the cutting blade tip 92 of the cutting blade 22 actuates the cutting blade tip sensor 24. At the point of actuation of the cutting blade tip sensor 24, the cutting blade tip sensor 24 signals the circuitry indicating that the cutting blade 22 has been extended a predetermined length relative to the distal end 194 of the sleeve 176.

Advantageously, by actuating the cutting blade tip sensor 24 with the cutting blade tip 92, the location of cutting blade tip 92 relative to the sleeve distal end 194 is known regardless of the amount of wear experienced by the cutting blade tip 92. Once the location of the cutting blade tip 92 relative to the sleeve distal end 194 is known, the cutting blade tip 92 can be extended or retracted to a desired length relative to the sleeve distal end 194 to provide a preset blade depth for the specific sheet on the top plate 16. In addition, a signal indicating the cutting blade 22 needs replacement can be generated by the circuitry if the fine adjust motor 154 extends the cutting blade 22 beyond a predetermined distance from the retracted position prior to actuating the cutting blade tip sensor 24 indicating that the wear on the cutting blade 22 has exceeded a predetermined amount.

Of course, if the cutting head 18 only includes a head pressure motor 152 with the cutting blade 22 in a fixed extended position, only the head pressure motor 152 is actuated to engage the cutting blade tip 92 with the cutting blade tip sensor 24. Likewise, if the cutting head 18 only includes a fine adjust motor 154 with the cutting blade assembly 168 in a fixed position, only the fine adjust motor 154 is actuated to engage the cutting blade tip 92 with the cutting blade tip sensor 24. Moreover, although mounting the cutting blade tip sensor 24 in the housing 12 to determine the location of the cutting blade tip 92 in the extended position is preferred, the cutting blade tip sensor 24 can be mounted in or adjacent to the sleeve 176 to determine the cutting blade tip 92 location without departing from the scope of the invention.

In the preferred embodiment, once the position of the cutting blade tip 92 is known, the head pressure motor 152 raises the cutting blade assembly 168 away from the cutting tip sensor 24, the fine adjust motor 154 sets the desired blade depth, and the gantry system 96 moves the cutting blade 22 to the starting point of the pattern being cut into the sheet. At the starting point of the pattern being cut, the head pressure motor 152 lowers the cutting blade assembly 168 to the lower position in which the distal end 194 of the sleeve 176 engages the sheet being cut plunging the cutting blade 22 into the sheet. Preferably, the cutting blade assembly 168 is lowered to a pre-determined lower position to develop the proper downward force for optimal cutting. The gantry system 96 then moves the cutting blade 22 along the pattern being cut into the sheet.

Once the cutting blade 22 requires replacement, as evidenced by visual inspection or by the amount of axial blade travel required to actuate the cutting blade tip sensor 24, the cross arm housing 248 is opened by pivoting the cross arm cover 252 to expose the cutting head 18. The user then pivots the cutting head 18 about the shoulder bolt 134 to the blade replacement position to expose the open lower end 242 of the sleeve lower portion 186 for easy access to the cutting blade 22.

Once the cutting head 18 has been pivoted about the shoulder bolt 134, the user exerts an axial force on the upper end 216 of the fine adjust motor shaft 212 to urge the lower cutting end 236 of the cutting blade 22 out of the open lower end 242 of the lower portion 186 of the sleeve 176. The user then grasps the detachable cutting blade 22 and pulls the cutting blade 22 out of the sleeve 176. A new blade is then inserted into the sleeve 176 through the open lower end 242 of the lower portion 186 of the sleeve 176 into engagement with the thrust bearing 228. The cutting head 18 is then returned to the cutting position and the cross arm cover 252 is closed to cover the cutting head 18.

While there has been shown and described what is at present considered the preferred embodiment of the invention, it will be obvious to those skilled in the art that various changes and modifications can be made therein without departing from the scope of the invention defined by the appended claims.

We claim:

1. A sheet cutting apparatus comprising:
a top plate for supporting a sheet being cut;
a cutting head movable above said top plate and having a cutting blade movable toward said top plate; and
a cutting blade tip sensor engaging a tip of said cutting blade and indicating a location of said tip relative to said cutting head.

2. The sheet cutting apparatus as in claim 1, in which said cutting blade tip sensor indicates a predetermined extended length of said cutting blade from said cutting head.

3. The sheet cutting apparatus as in claim 1, in which said cutting blade tip sensor is mounted adjacent to said top plate.

4. The sheet cutting apparatus as in claim 1, in which said cutting head is mounted in a gantry system which moves said cutting head over said top plate.

5. The sheet cutting apparatus as in claim 1, in which a first motor moves said cutting blade toward said top plate by lowering a cutting blade assembly including said cutting blade toward said top plate.

6. The sheet cutting apparatus as in claim 1, in which a first motor moves said cutting blade toward said top plate by extending said cutting blade toward said top plate.

7. The sheet cutting apparatus as in claim 6, in which said first motor forms part of a cutting blade assembly including said cutting blade, and a second motor moves said cutting blade assembly toward said top plate.

8. A method of operating a sheet cutting apparatus having a top plate for supporting a sheet being cut, a cutting head disposed above said top plate and having a cutting blade movable toward said top plate, and a cutting blade tip sensor engaging a tip of said cutting blade and indicating a location of said tip relative to said top plate, said method comprising:
locating said cutting blade over said blade tip sensor;
actuating said blade tip sensor with a tip of said cutting blade; and
producing a signal indicating that the tip of said cutting blade actuated said blade tip sensor.

9. The method as in claim 8, in which said blade tip sensor is actuated by extending said blade toward said blade tip sensor.

10. The method as in claim 8, in which locating said cutting blade over said blade tip sensor moves said cutting blade to a position that is not over said top plate.

11. The method as in claim 8, in which locating said cutting blade over said blade tip sensor includes moving the cutting head in a direction along a length of a cross bar disposed above the top plate.

12. The method as in claim 11, in which locating said cutting blade over said blade tip sensor includes moving said cross bar in a direction transverse to the direction of said cutting head.

13. The method as in claim 8, in which actuating said blade tip sensor with a tip of said cutting blade includes actuating a first motor to lower a cutting blade assembly including said cutting blade.

14. The method as in claim 8, in which actuating said blade tip sensor with a tip of said cutting blade includes actuating a first motor to extend said cutting blade toward said blade tip sensor.

15. The method as in claim 14, in which actuating said blade tip sensor with a tip of said cutting blade includes actuating a second motor to lower a cutting blade assembly including said cutting blade, and said first motor extends said cutting blade from said cutting blade assembly.

16. The method as in claim 15, including actuating said first motor to a desired blade depth after actuating said blade tip sensor.

17. The method as in claim 8, including producing a signal indicating the blade should be replaced upon a determination that travel of said blade to actuate said blade tip sensor with said tip of said cutting blade exceeded a predetermined amount of travel.

18. A sheet cutting apparatus comprising:
a gantry system;
a top plate for supporting a sheet being cut beneath said gantry system;
a cutting head fixed to said gantry system above said top plate and having an extendible cutting blade, wherein said gantry system moves said cutting head over said top plate; and
a cutting blade tip sensor engaging a tip of said cutting blade and indicating a location of said tip relative to said cutting head.

19. The sheet cutting apparatus as in claim 18, in which said cutting blade tip sensor indicates a predetermined extended length of said cutting blade from said cutting head.

20. The sheet cutting apparatus as in claim 18, in which said cutting blade tip sensor is mounted adjacent to said top plate.
